(19) United States
(12) Patent Application Publication
(10) Pub. No.: US 2018/0336562 A1
(43) Pub. Date: Nov. 22, 2018

(54) SYSTEM TO PROVIDE ENHANCED SECURITY AGAINST UNAUTHORIZED USE OF A CASHLESS TRANSACTION CARD

(71) Applicant: MASTERCARD INTERNATIONAL INCORPORATED, Purchase, NY (US)

(72) Inventors: Pavel Umanski, Yorktown Heights, NY (US); Danielle Crosswell, Briarcliff Manor, NY (US); Todd Christian Lowenberg, Redding, CT (US); Edward M. Lee, Scarsdale, NY (US); Jin Peng, Fremont, CA (US); Adarsh Kumar Recriwal, Delhi (IN)

(21) Appl. No.: 15/597,626

(22) Filed: May 17, 2017

(51) Int. Cl. G06Q 20/40; G06K 7/14

(52) U.S. Cl. CPC G06Q 20/4014; G06K 7/1417; G06K 7/1413

(57) ABSTRACT

A novel solution to the vexing problem of how to secure a cashless transaction card and card account from unauthorized use. By adding enhanced security to a cashless transaction card, the present invention significantly reduces, and may in fact eliminate, unauthorized use of a cashless transaction card and card account. In accordance with embodiments of the present invention, a cashless transaction card and card account are linked with an authentication device that must be in proximity with the cashless transaction card when that card is being used for a cashless transaction. In this way, the present invention makes unauthorized use of the card significantly less likely. The authentication device is chosen by the owner and linked thereby with the cashless transaction card and card account. Only when the authentication device is in proximity with the cashless transaction card will a cashless transaction be authorized.

### FIELD OF THE INVENTION

The present invention relates to a system that provides enhanced security against unauthorized use of a cashless transaction card.

### BACKGROUND OF THE INVENTION

Identity theft, and more particularly, credit card theft, presents an ever-present risk for cashless transactions. Whether swiping a credit card at a bricks and mortar merchant point of sale terminal, using a smartphone or similar electronic device during a cashless transaction, shopping on the Internet, or any other type of transaction for the purchase of goods and/or services during which a cardholder provides to a merchant access to certain financial information of the cardholder, the cardholder is exposed to some level of risk because his/her financial information is conveyed to the merchant during the transaction. It is possible for the cardholder's financial information to be intercepted or obtained (i.e., stolen) while completing the cashless transaction, and then put to unauthorized use by the person or entity that stole the information. It is also possible for the cardholder's card to be lost or stolen, and put to unauthorized use before the cardholder can close the credit card account.

Although attempts have been made to implement enhanced security features for credit cards, such as placing chips, pictures and other identifiers on the credit cards, credit card and identify thieves are clever, and continue to find ways to circumvent whatever security enhancements are attempted.

Thus, there exists a need for a solution to the above-identified shortcomings of the prior art.

### SUMMARY OF THE INVENTION

The present invention provides a novel solution to a pervasive and wide-ranging problem: how to secure a cashless transaction card and card account from unauthorized use. The present invention adds enhanced security to a cashless transaction card and card account that significantly reduces, and may in fact eliminate, unauthorized use of a cashless transaction card and card account. By linking the cashless transaction card and card account with an authentication device, and by requiring that that authentication device be in proximity with the cashless transaction card when that card is being used for a cashless transaction, the present invention makes unauthorized use of the card significantly less likely. The authentication device is chosen by the owner and linked thereby with the cashless transaction card and card account. Consequently, the owner (i.e., the cardholder) has control and most likely possession of the authentication device. Only when the authentication device is in proximity with the cashless transaction card will a cashless transaction be authorized. Thus, if a cashless transaction card is lost or stolen, or even if the cashless transaction card account number is stolen, neither can be used unless the authentication device is in proximity with the person attempting to complete a cashless transaction.

An embodiment of the present invention is directed to a system to provide enhanced security against unauthorized use of a cashless transaction card. The system comprises an enhanced security database containing a plurality of database records, each for at least one cashless transaction card, each of the plurality of database records containing a primary authentication. The system further comprises a server having a processor operable by a program of instructions stored in memory, the server being connectable to a network, the enhanced security database being accessible by the server. The system still further comprises an authentication device having an authentication. The program of instructions, when executed by the server processor, cause the server processor, during a cashless transaction, to: receive an initiation of a cashless transaction, the initiation including an identifier of a cashless transaction card; and determine if the identifier of the cashless transaction card corresponds with one of the plurality of database records in the enhanced security database. When the identifier of the cashless transaction card corresponds with one of the database record in the enhanced security database, the program of instructions, when executed by the server processor, further cause the server processor, during a cashless transaction, to: determine the authentication from the authentication device; determine if the authentication from the authentication device is the same as the primary authentication in the one of the plurality of database records; and authorize use of the cashless transaction card for the cashless transaction only when the authentication is the same as the primary authentication.

An alternative embodiment of the present invention is directed to a system to provide enhanced security against unauthorized use of a cashless transaction card. The system of this embodiment comprises an enhanced security database, a server having a processor operable by a program of instructions stored in memory, the server being connectable to a network, the enhanced security database being accessible by the server, and an authentication device having an authentication. The program of instructions, when executed by the server processor, causes the server processor, prior to a cashless transaction, to create a database record containing a primary authentication in the enhanced security database for at least one cashless transaction card. The program of instructions, when executed by the server processor, further causes the server processor, during a cashless transaction, to: receive an initiation of a cashless transaction, the initiation including an identifier of a cashless transaction card; and determine if the identifier of the cashless transaction card corresponds with at least the database record in the enhanced security database. When the identifier of the cashless transaction card corresponds with at least the database record in the enhanced security database, the program of instructions, when executed by the server processor, further causes the server processor, during a cashless transaction, to: determine the authentication from the authentication device; determine if the authentication from the authentication device is the same as the primary authentication in at least the database record; and authorize use of the cashless transaction card for the cashless transaction only when the authentication is the same as the primary authentication.

An alternative embodiment of the present invention is directed to a system to provide enhanced security against unauthorized use of a cashless transaction card. The system of this embodiment comprises an enhanced security database containing a plurality of database records, each for at least one cashless transaction card, each of the plurality of database records containing a primary authentication. The system further comprises a server having a processor operable by a program of instructions stored in memory, the server being connectable to a network, the enhanced security database being accessible by the server. The program of instructions, when executed by the server processor, causes the server processor, during a cashless transaction, to: receive an initiation of a cashless transaction, the initiation including an identifier of a cashless transaction card; and determine if the identifier of the cashless transaction card corresponds with a database record in the enhanced security database. When the identifier of the cashless transaction card corresponds with one of the database record in the enhanced security database, the program of instructions, when executed by the server processor, causes the server processor, during a cashless transaction, to verify the primary authentication, and authorize use of the cashless transaction card for the cashless transaction only when the primary authentication is verified.

### DESCRIPTION OF THE DIAGRAMS

Embodiments of the present invention will now be described with reference to the following figures, wherein:

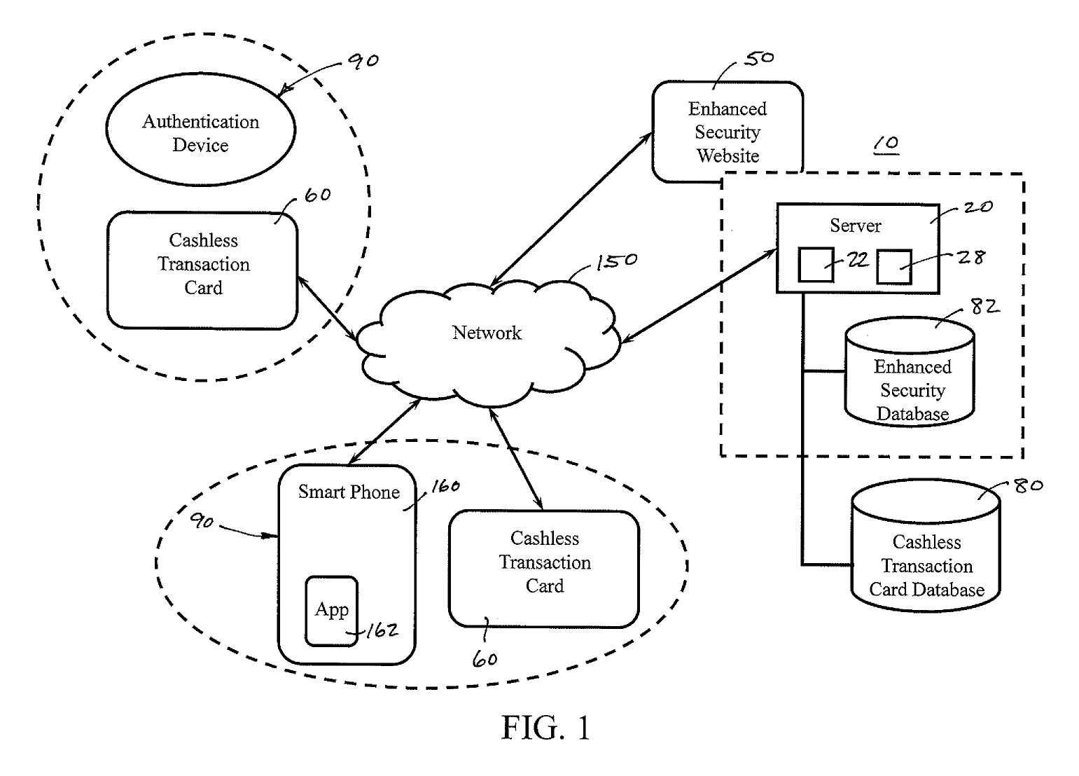

FIG. 1 depicts a system for linking an authentication device with a cashless transaction card for providing enhanced security against unauthorized use thereof, including certain devices and components configured in accordance with embodiments of the present invention;

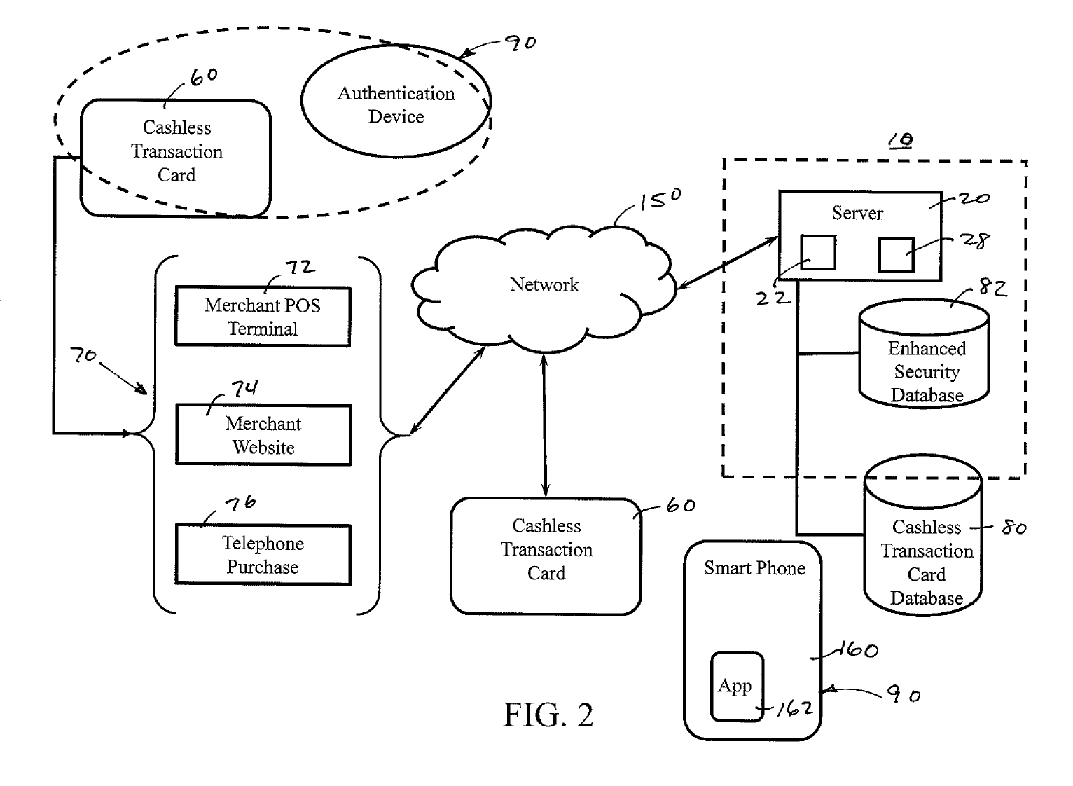

FIG. 2 depicts a system for using an authentication device with a cashless transaction card linked with for providing enhanced security against unauthorized use thereof, including certain devices and components configured in accordance with embodiments of the present invention;

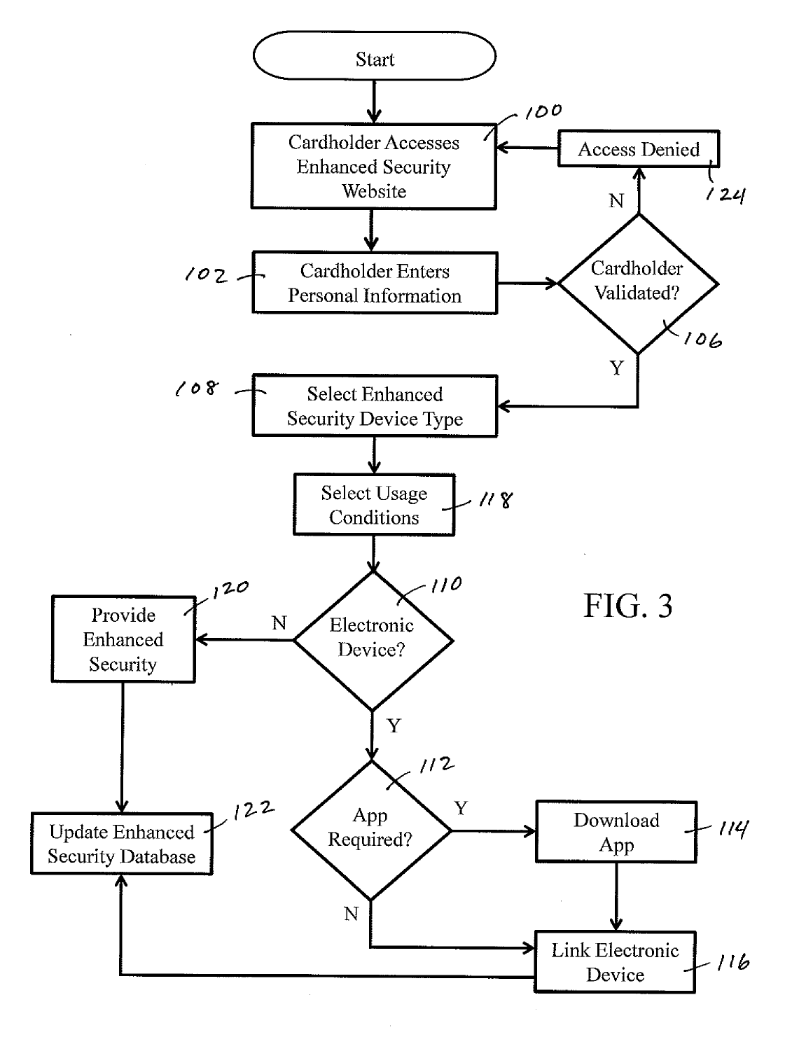

FIG. 3 is a flow diagram of a process for linking a cashless transaction card with an authentication device in accordance with embodiments of the present invention;

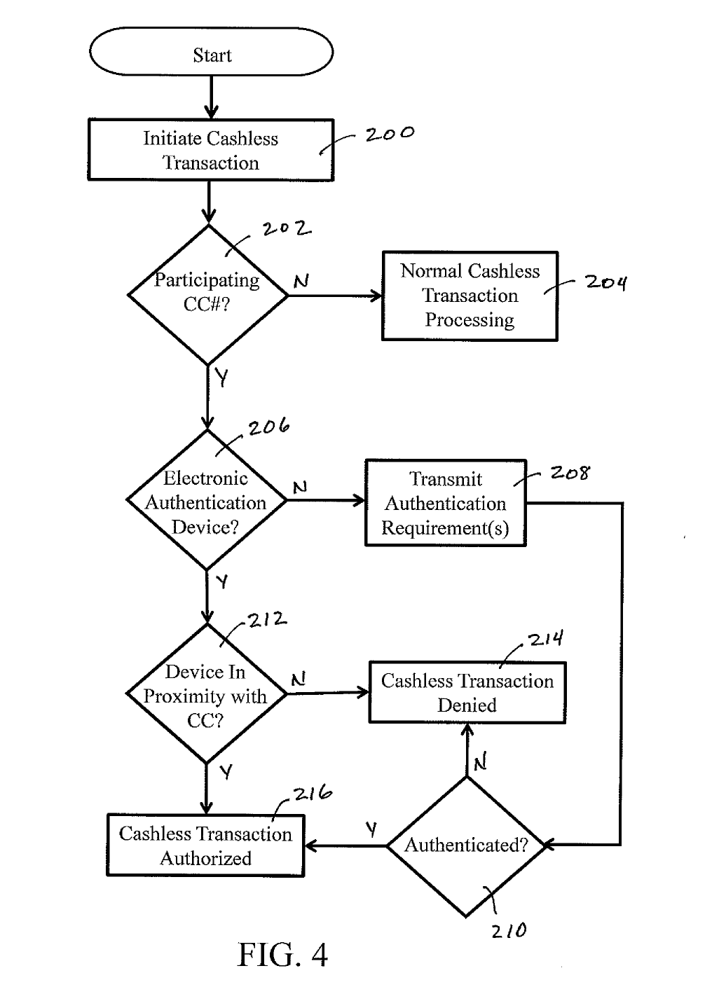

FIG. 4 is a flow diagram of a process of using a cashless transaction card with an authentication device in accordance with embodiments of the present invention;

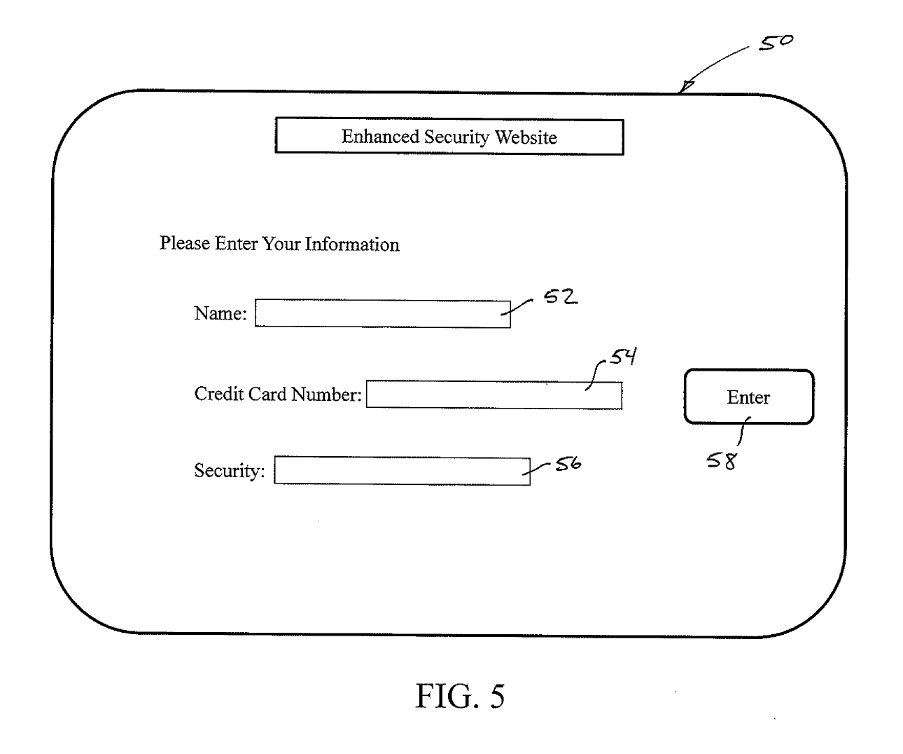

FIG. 5 depicts a page of an enhanced security website via which a cardholder can begin the process for linking a cashless transaction card with an authentication device in accordance with embodiments of the present invention;

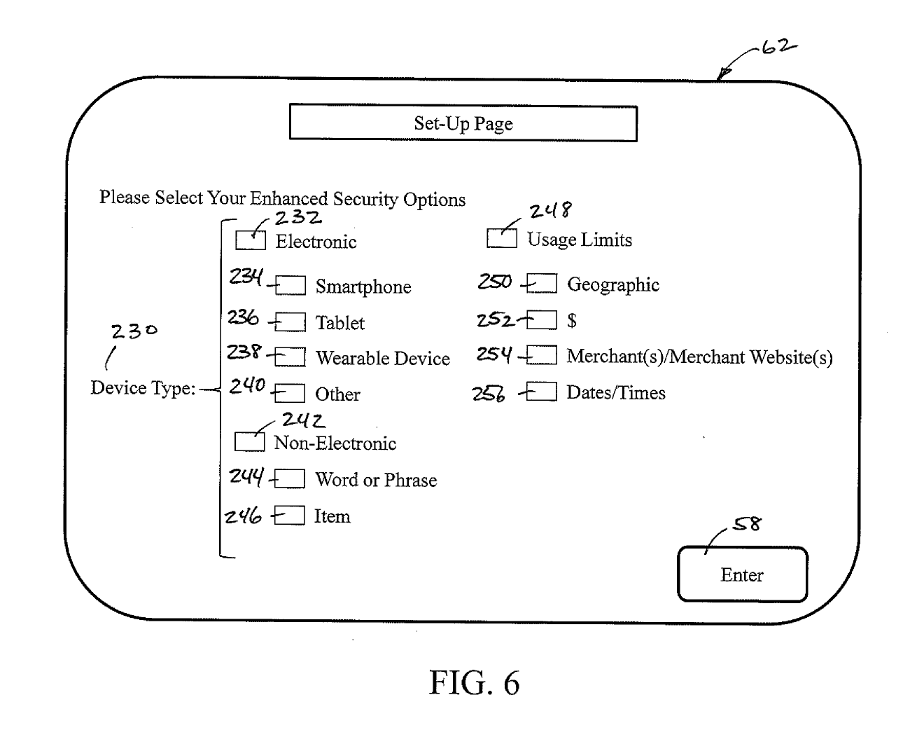

FIG. 6 depicts a Set-Up Page of an enhanced security website via which a cardholder can set-up a link between a cashless transaction card with an authentication device in accordance with embodiments of the present invention;

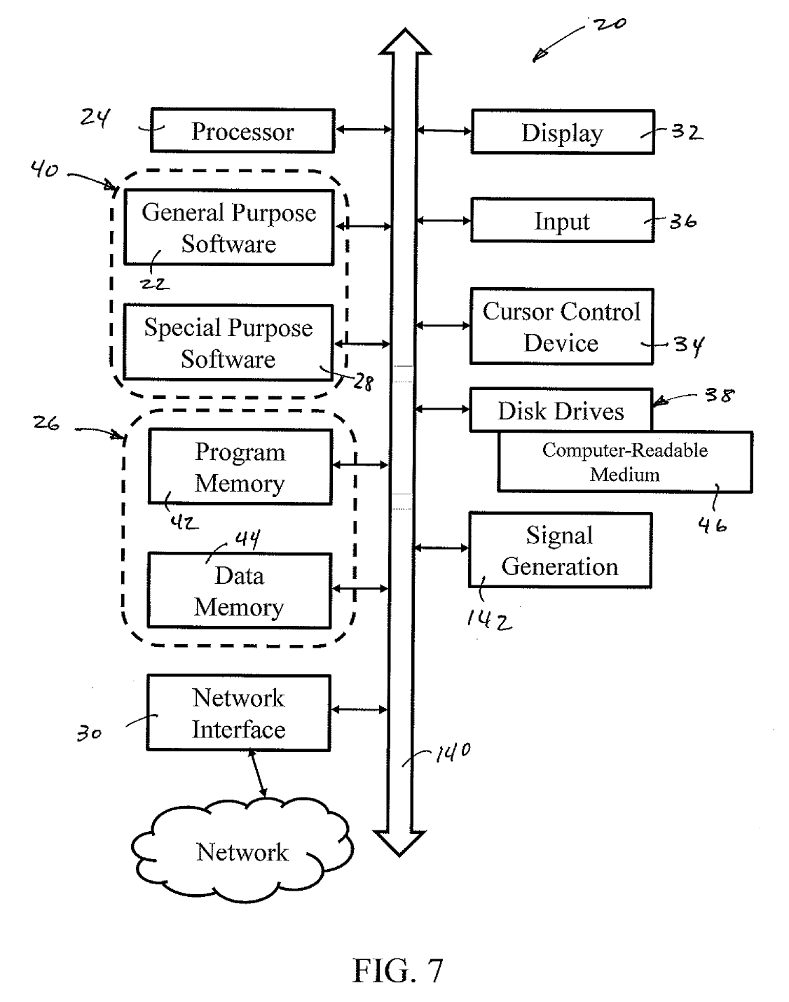

FIG. 7 is a block-diagram schematic of a server in accordance with embodiments of the present invention; and

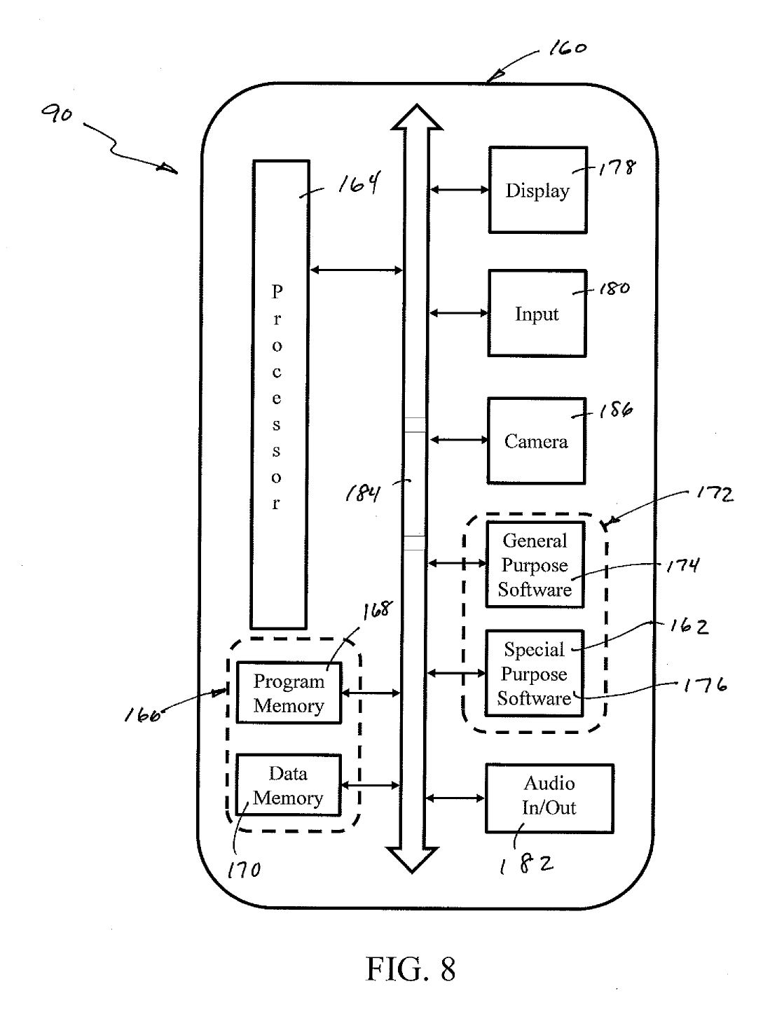

FIG. 8 is a block-diagram schematic of a user mobile device in accordance with embodiments of the present invention.

### DESCRIPTION OF EMBODIMENTS OF THE INVENTION

The following sections describe exemplary embodiments of the present invention. It should be apparent to those skilled in the art that the described embodiments of the present invention are illustrative only and not limiting, having been presented by way of example only. All features disclosed in this description may be replaced by alternative features serving the same or similar purpose, unless expressly stated otherwise. Therefore, numerous other embodiments of the modification thereof are contemplated as falling within the scope of the present invention as defined herein and equivalents thereto.

Throughout the description, where items are described as having, including, or comprising one or more specific components, or where methods are described as having, including, or comprising one or more specific steps, it is contemplated that, additionally, there are items of the present invention that consist essentially of, or consist of, the one or more recited components, and that there are methods according to the present invention that consist essentially of, or consist of, the one or more recited processing steps.

As will be appreciated by one skilled in the art, the present invention may be embodied as a system, method, or computer program product. Accordingly, the present invention may comprise hardware element(s), software element(s) (including firmware, resident software, micro-code, etc.), or a combination of hardware and software elements that may generally be referred to herein as a “server,” “computing system,” “computer system,” “system,” etc. It is commonly known in the art these devices may be associated with one or more processors or central processing units. Furthermore, the present invention may take the form of a computer program product embodied in any tangible medium of expression having computer usable program code embodied in the medium.

Computer software (i.e., computer program code, applications, etc.) for carrying out aspects of the present invention may be written in any combination of one or more programming languages, including an object-oriented programming language such as Java, Smalltalk, C++, or the like and conventional procedural programming languages, such as Visual Basic, “C,” or similar programming languages, it being obvious to a person skilled in the art that embodiments of the present invention are not dependent upon a specific or particular type of software or application code.

The present invention is described below with reference to flowchart illustrations and/or block diagrams of methods, apparatuses (systems), and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be stored in memory of a general purpose computer, special purpose computer, or other programmable data processing apparatus to produce a machine, such that the instructions, which execute via the processor of the computer or other programmable data processing apparatus, implement aspects of the present invention as depicted in the flowchart and/or block diagrams. The computer program instructions comprise general purpose software and special purpose software, the latter of which renders the computer a special purpose computing device insofar as the special purpose software is operably controlling certain functions of the computer directed to the present invention. These computer programmable instructions may also be stored in a computer-readable medium that may comprise a part of the computer or that may be loadable onto the computer and that can direct a computer or other programmable data processing apparatus to function in a particular manner, such that the instructions stored in the computer-readable medium produce an article of manufacture including instruction means which implement the function/act specified in the flowchart and/or block diagram.

As used herein the term “cashless transaction” refers to a transaction at least between a merchant, an issuer bank, and a customer or cardholder, there terms being used interchangeably herein, using a cashless transaction number associated with a cashless transaction card or device capable of carrying out a cashless transaction. As used herein, the term “cashless transaction card” includes, by way of illustration and not limitation, a credit card, debit card, gift card, and other similar cards. References to a cashless transaction card are also intended to refer to an account and account number associated with the cashless transaction card. Thus, reference to a cashless transaction card herein does not only refer to the physical card, but also to the account and account number for that card. As used herein, the term “cashless transaction device” includes an electronic or electro-mechanical device capable of carrying-out aspects of a cashless transaction including, by way of illustration and not limitation, a smart phone, a tablet, a laptop computer, and other similar electronic or electro-mechanical devices.

Referring next to the drawings in detail, embodiments of the present invention will now be discussed. In general, the system 10 of the present invention enables a cardholder to add enhanced security to his/her credit card account that will make unauthorized use of the credit card account more difficult. According to embodiments of the present invention, a cardholder can link his/her credit card account to an authentication device. Once linked, cashless transactions using the credit card account are only authorized when the authentication device is in proximity to the credit card. Thus, stolen or lost credit cards, or stolen credit card numbers cannot be used unless they are in proximity to the authentication device—to which the thief will not have access and will likely not even know exists.

Referring first to FIGS. 1 and 2, an illustrative configuration of a system 10 in accordance with embodiments is depicted. In FIG. 1, the system 10 is depicted during linking a cashless transaction card with an authentication device, and in FIG. 2, the system 10 is depicted during use of a cashless transaction card linked with an authentication device.

The system 10 comprises a server 20 connectable to a network 150 that may be any known or hereafter developed network such as, by way of illustration and not limitation, a local area network (“LAN”), wireless network, cellular network, and variations and combinations thereof. As used herein, the term “connectable” refers to various states of connection between electronic devices.

For example, “connectable” refers to a physical connection between electronic devices, a wireless connection between electronic devices, a combination of a physical and wireless connection between electronic devices, a transient or episodic connection between electronic devices. As used herein the term “connectable” also refers to various point in time with respect to connectivity between electronic devices such as, by way of non-limiting example, during the time when electronic devices are not connected, during the time when electronic devices are connecting, and during the time when electronic devices are connected.

The server 20 has installed and operational thereon general purpose software 22 to carry-out traditional functions of a server (see, e.g., discussion of FIG. 7, below), and special purpose software 28 to carry-out aspects of the present invention. The special purpose software 28 renders the server 20 a special purpose computing device insofar as the special purpose software 28 is operably controlling certain functions of the server 20 directed to the present invention.

The system 10 includes an enhanced security database 82 containing separate database entries for each of a plurality of cashless transaction cards. Each entry identifies a cashless transaction card and an enhanced security identifier linked with that card. An enhanced security identifier may correspond to an electronic authentication device, a non-electronic authentication device, or both. Each database entry may also contain other information that may be utilized to authorize use of the card. For example, the database entry may contain usage conditions that are considered to determine whether to approve or deny a cashless transaction.

The server 20 may also access a cashless transaction database 80 containing separate database entries for each of a plurality of cashless transaction card accounts for each of a plurality of cardholders. The cashless transaction database 80 provides restricted access to information about cashless transactions carried-out by a plurality of cardholders. The cashless transaction database 80 contains a plurality of database entries, each associated with a separate cardholder with each of the plurality of database entries containing records of a plurality of cashless transactions carried out by the cardholder associated with the database entry. Each record in the cashless transaction database 80 for each cardholder may also contain information specific to that cardholder such as, by way of non-limiting example, personal information (e.g., name, address, birthday, etc.), financial information, and security information. The cashless transaction database 80 may also include information about a cardholder's spending habits. Other information relating to or about a cardholder may also be contained in each cardholder record of the cashless transaction database 80. The server 20 is connectable to the cashless transaction database 80 and other databases (not shown) via direct connection to the server 20 (as shown in FIG. 1), via the network 150, or via another network (e.g., a LAN).

In an embodiment of the present invention, the system 10 also comprises an authentication device 90 and special purpose software 162, including an application or app, that is downloadable from the server 20 to the authentication device 90 to enable that device 90 to carry-out certain aspects of the present invention, as discussed in detail herein. The authentication device 90 may be an electronic device such as, by way of non-limiting example, a smart phone, tablet, wearable electronic device such as smart jewelry (e.g., FitBit®, smart watch, smart glasses, or any other now known or hereafter developed device that sends and receives information of any type over a network and is capable of providing enhanced security in accordance with embodiments of the present invention). In an embodiment of the present invention, the authentication device 90 is a smart phone. Alternatively, or in addition, the authentication device 90 may be a non-electronic device such as, for example, a word, a symbol, a picture, a computer-readable code (e.g., QR code), a coded card or pass-key, a phrase, an article of clothing (e.g., jewelry), etc.

With continued reference to FIG. 1, and additional reference to FIG. 7, a server 20 in accordance with embodiments of the present invention will now be discussed in more detail. The server 20 may be a general purpose computing device having a plurality of devices and components operably connected over a bus 140. The server 20 has one or more processors 24 or central processing units (“CPU”). Although the server 20 of the present invention is discussed as having a single processor 20, a server having multiple processor, either separate or integrated in a multi-core processor, for example, are also contemplated by and within the scope and spirit of the present invention. Reference to processor in the singular herein shall be interpreted to include any variation and number of processors. The processor 24 is operable by at least one program of instructions 40 comprising general purpose software 22 to carry out functions that enable the server 20 to interface with its various hardware components (discussed further below), and to interface and communicate with other devices. The processor 24 of the present invention is also operable by at least one program of instructions 40 comprising special purpose software 28 to carry out aspects of the present invention. The general purpose software 22 and special purpose software 28 may be stored on the server 20 in memory 26 that may comprise program memory 42 and data memory 44, or it may be stored on one or more disk drives 38 comprised of a computer-readable medium 46, or it may be stored in/on any combination of the foregoing. As used herein, the term “memory” is intended to include all currently known or hereafter developed types of permanent or temporary storage devices or components in a computing device. Exemplary memory types include, by way of illustration and not limitation, Random Access Memory (RAM)—further including Dynamic RAM (DRAM), Static RAM (SRAM), and Direct Rambus DRAM (DRDRAM), Read Only Memory (ROM)—further including Programmable ROM (PROM), erasable PROM (EPROM), and Electrically EPROM (EEPROM), cache memory, hard drives and flash memory.

The server 20 further includes a display 32, input device(s) 36 (e.g., a keyboard), cursor control device(s) 34 (e.g., a mouse), signal generation device(s) 142 (e.g., a speaker or remote control), and network interface device(s) 30 that enable the server 20 to selectively connect to and with a network 150 and send or receive voice, video or data, and to communicate over the network 150 as controlled by the program of instructions 40.

The memory 26 and disk drives 38 each comprise computer-readable medium that may each include a single medium or multiple media (e.g., a centralized or distributed database, and/or associated caches and servers) that store the one or more sets of instructions 40. The term “computer-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and/or a digital file attachment to e-mail or other self-contained information archive or set of archives that is considered a distribution medium equivalent to a tangible storage medium. Accordingly, the embodiment is considered to include anyone or more of a tangible computer-readable medium or a tangible distribution medium, as listed herein and including art-recognized equivalents and successor media, in which the software implementations herein are stored. The term “computer-readable medium” shall also be taken to include any medium that is capable of storing, encoding, or carrying a set of instructions in the general purpose software 22 and in the special purpose software 28.

In a particular non-limiting, example embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification may describe components and functions implemented in the embodiments with reference to particular standards and protocols, the disclosed embodiments are not limited to such standards and protocols.

In accordance with various embodiments, the present invention may be implemented as one or more software programs running on one or more computing devices and one or more computer processors. Dedicated hardware implementations including, but not limited to, application specific integrated circuits, programmable logic arrays and other hardware devices can likewise be constructed to implement the present invention. Furthermore, alternative software implementations including, but not limited to, distributed processing or component/object distributed processing, parallel processing, or virtual machine processing can also be constructed to implement the present invention.

With continued reference to FIG. 1 and additional reference to FIG. 8, an embodiment of a smart phone 160 as an authentication device 90 is depicted. The present invention is not limited to a smart phone 160 as the authentication device 90, but includes within its scope and spirit any now known or hereafter developed electronic device capable of carrying out certain aspects and functions of the present invention, as discussed in detail herein. For a smart phone 160 authentication device 90, connection between the server 20 and the authentication device 90 is made at least in part over a cellular network 150. The smartphone 160 has installed and operational thereon a program of instructions 172 including general purpose software 174 and special purpose software 176. The general and special purpose software 174, 176 comprises a program or programs of instructions stored in memory 166 of the smartphone 160 that, when executed by a processor 164 of the smartphone 160, causes the processor 164 to carry-out aspects of the present invention. An application or app 162 comprises a part of the special purpose software 176, and is downloadable to the smartphone 160 over the network 150 from the server 20. The general purpose software 174 and special purpose software 176 may be stored in memory 166 that may comprise program memory 168 and data memory 170.

The special purpose software 174, including the app 162, enables the smartphone 160 to carry-out aspects of the present invention, and renders the smartphone 160 a special purpose device insofar as the special purpose software 174, including the app 162, is operably controlling certain functions of the smartphone 160.

The smartphone 160 may have a plurality of devices and components operably connected over a bus 184. These devices and components may include, by way of illustration and not limitation, a camera 186 or image capture device capable of capturing and storing in memory 166 an image. The camera 186 is also suitable for reading a barcode label, or capturing, recording, interpreting other objects. The smartphone 160 also includes an input 180 that may comprise an alphanumeric keyboard or keypad, whether implemented as actual hardware or depicted on a display 178, that enables a user to enter alphanumeric information and to effect control of various aspects of the smartphone 160. The smartphone 160 also includes a display 178 via which information, images, graphical user interfaces, etc. are displayed to the user and accessible thereby. The display 178 may comprise a touch-screen by which a user may input to the smartphone 160 by touching the display 178 at the appropriate location, in which case at least certain aspects of the input 180 are provided via the display 178. The smartphone 160 also includes an audio in/out 182 that enables sound to be input to and output from the smartphone 160.

In use, the present invention enables a cardholder to add enhanced security to his/her cashless transaction card 60 by identifying an authentication device that must be in proximity to the card for a cashless transaction using the card to be approved.

With continued reference to FIGS. 1 and 2, and with additional reference to FIGS. 3, 5 and 6, use of the present invention will now be discussed in detail. As a first step, a cardholder must set-up his/her cashless transaction card 60 with enhanced security according to embodiments of the present invention by accessing an enhanced security website 50 at 100 of FIG. 3, a home page of which is depicted in FIG. 5. At the homepage, the cardholder enters, at 102, certain identifying information including, by way of illustration and not limitation, name 52 and cashless transaction card number 54. As a first level of security, the cardholder must also enter, at 102, security information 56 that may have been provided to the issuer of the cashless transaction card 60 when the cardholder first opened the cashless transaction card account. Once the cardholder enters the required information on the home page, he/she selects enter 58 to proceed. The special purpose software 28 of the sever 20 will validate the information at 106 by determining first if there is an entry in the cashless transaction database 80 for the cashless transaction card 60 and, if so, whether the information entered by the cardholder matches the information in the database entry for that card.

If the information entered by the cardholder is not validated at 106, the cardholder will be denied access at 124 to linking a cashless transaction card 60 with an authentication device 90. If the information entered by the cardholder is validated at 106, the cardholder will proceed to a Set-Up Page 62, as depicted in FIG. 6, at which the cardholder can proceed to set up enhanced security for his/her cashless transaction card 60. At 108 in FIG. 3, the cardholder decides/selects the type of authentication device 90 to link with the cashless transaction card 60 to provide enhanced security. As depicted in FIG. 6, the cardholder can choose a device type 230 that is either electronic 232 or non-electronic 242, or alternatively, the cardholder can select both an electronic 232 and non-electronic 242 devices as the device type 230. Illustrative options for an electronic device 232 include, by way of illustration and not limitation, a smartphone 234, a tablet 236, a wearable electronic device 238 such as, for example, smart jewelry like a FitBit®, a smart watch, smart glasses, or some other electronic device 240 that sends or receives information of any type over a network and is capable of providing enhanced security in accordance with embodiments of the present invention. Non-electronic device types include, for example, a word or phrase 244, or an item 246 such as, for example a QR/Bar code, card key, etc.

The cardholder can also select usage conditions, at 118 of FIGS. 3 and 248 of FIG. 6, which facilitate further additional security measures for use of the cardholder's cashless transaction card and card account. These conditions may include, by way of non-limiting example, geographic conditions 250 restricting use of the cashless transaction card and card account to a predefined and limited geographic area, e.g., only within the continental United States. The usage conditions may also include a maximum dollar limitation 252 for the card, usage only at predefined merchants or merchant web sites 254, or at predefined dates and/or times 256. Other usage conditions are contemplated by, and with the scope and spirit of the present invention.

After selecting the type of authentication device 90, the cardholder selects Enter 58 on FIG. 5 to transmit the information provided via the Set-Up Page 62 on FIG. 6 to the special purpose software 28 of the server 20, which determines, at 110 of FIG. 3, whether an electronic device has been selected. When an electronic device is selected as the device type, the present invention associates linking that electronic authentication device 90 with the cardholder's cashless transaction card. The present invention first determines, at 112, whether the selected electronic authentication device 90 has installed thereon an application (“app”) 162 enabling communication with the device. If an app 162 is not installed on the selected electronic authentication device 90, the present invention downloads an app 162 to the device 90, at 114. The app 162 now installed in the electronic authentication device 90 enables linking of that device, at 116, with the enhanced security database 82, at 122. If an app 162 is already installed on the electronic authentication device 90, the present invention proceeds to link that device, at 116, with the enhanced security database 82, at 122. If, at 110, the present invention determines that an electronic device has not been selected (i.e., a non-electronic device has been selected), the cardholder provides a word or phrase, or multiple words or phrases, or other unique identifiers as enhanced security at 120. At 122, the enhanced security database 82 is updated with this enhanced security provided by the cardholder. The authentication device 90 is linked to the cashless transaction card by capturing a unique identifier for the authentication device 90 and storing that identifier in the database entry in the enhanced security database 82 for the cardholder's cashless transaction card. The unique identifier for the authentication device 90 serves as an authentication usable by the present invention during a cashless transaction in accordance with embodiments of the present invention.

In order for the present invention to associate during set-up and link during use the authentication device 90 with the cardholder's cashless transaction card and card account, the authentication device 90 must be uniquely identifiable by the special purpose software 28 of the server 20. For example, electronic devices contain or may contain a unique identifier, or UID, that makes electronic devices differentiable from each other. In accordance with embodiments of the present invention, the UID for a particular electronic authentication device 90 is identifiable by the app 162 and may be received by the special purpose software 28 of the server 20 and stored in the cashless transaction database entry for the cardholder and cashless transaction card and card account. The UID may thereafter be used to validate and authorize a cashless transaction in accordance with embodiments of the present invention.

The UID may be generated in any number of now known or hereafter developed ways for generating a unique identifier for an electronic device including, by way of illustration and not limitation, using any one or any combination of the device manufacturer, device operating system and device serial number to generate a UID. Preferably, the UID is not write-accessible by the user of the electronic device, or by any hardware or software, including applications, on the electronic device or on another electronic device connectable with the electronic device.

The UID could also be generated according to one or more currently existing or hereafter developed standards. For example, mobile equipment identifiers, or MEIDs, are one type of UID that is specific to a mobile device, and that is not easily accessible or changeable. One type of UID used for code division multiple access (CDMA) systems is 56 bits long and identifies the manufacturer and serial number of a mobile device. This type of device MEID consists of 32 bits to specify the manufacturer and 24 bits to specify the serial number: with the first 4 bits of the manufacturer code being reserved and restricted to just a few values. There can also be a 4-bit check digit appended to the end, but this may not be transmitted between the mobile electronic device and the CDMA system.

A device MEID may be a 14-character hex code or an 18-digit decimal code. The 14-character hex code comprises an 8-character hex code to represent the manufacturer (2 for the reserved portion, 6 for the actual manufacturer portion), and a 6-character hex code to represent the serial number. Illustrative, exemplary formats for a 14-character hex code device MEID as shown in Table 1 include: 0xA10000009296F2 (using Ox to indicate that a hex value follows); OhA00000003FF642 (using 0h to indicate that a hex value follows); and ff000000b2c63a (without a prefix).

TABLE 1

| Reserved | | Manufacturer Code | | | | | | Serial Number | | | | | | CD |
|---|---|---|---|---|---|---|---|---|---|---|---|---|---|---|
| R | R | X | X | X | X | X | X | Z | Z | Z | Z | Z | Z | C |

The 18-digit decimal code comprises a 10-digit decimal number to represent the manufacturer, and an 8-digit decimal number to represent the serial number, e.g., 268435456010201020.

Referring next to FIGS. 2 and 4, use of the present invention will now be discussed in detail. As noted herein, the present invention provides a novel solution to a pervasive and wide-ranging problem: how to secure a cashless transaction card and card account from unauthorized use. The present invention adds enhanced security to a cashless transaction card and card account that significantly reduces, and may in fact eliminate, unauthorized use of a cashless transaction card and card account. By linking the cashless transaction card and card account with an authentication device, and by requiring that that authentication device be in proximity with the cashless transaction card when that card is being used for a cashless transaction, the present invention makes unauthorized use of the card significantly less likely. The authentication device is chosen by the owner and linked thereby with the cashless transaction card and card account. Consequently, the owner has control and most likely possession of the authentication device. Only when the authentication device is in proximity with the cashless transaction card will a cashless transaction be authorized. Thus, if a cashless transaction card is lost or stolen, or even if the cashless transaction card account number is stolen, neither can be used unless the authentication device is in proximity with the person attempting to complete a cashless transaction.

When a cardholder initiates a cashless transaction, at 200, at a merchant location 70 by swiping a cashless transaction card through, tapping a smartphone, or placing a smartphone in proximity with a point of sale (POS) terminal 72, or at a merchant website 74 or via telephone 76 by the cardholder entering his/her cashless transaction card number, the cardholder's cashless transaction card account number, along with other information, is received over the network 150 by the special purpose software 28 of the server 20, which then determines, at 202, whether the cashless transaction card 60 has been previously associated with an authentication device 90 by accessing the enhanced security database 82 to determine if there is an entry therein for the cashless transaction card. If the cashless transaction card is not registered for enhanced security in accordance with embodiments of the present invention, the cashless transaction proceeds in a typical manner, at 204. On the other hand, if the cashless transaction card has previously been associated with an authentication device 90, the special purpose software 28 of the server 20 determines, at 206, whether the previously associated authentication device is an electronic device by accessing the database entry in the enhanced security database 82 for the cashless transaction card. For electronic authentication devices 90, the special purpose software 28 determines, at 212, if the authentication device 90 identified in the enhanced security database 82 is in proximity with the cashless transaction card 60 by determining whether the authentication device 90 presented for the cashless transaction is the same as the one previously associated with the cashless transaction card. For example, the server 20 may link to the authentication device 90 through a smart phone via the special purpose software 176 (on FIG. 8) on the smart phone by communicating with the server 20 over a cell network/mobile data network/cashless transaction card network. The linkage of the electronic device to the cardholder's cashless transaction card can be done via near field communication (NFC) or Bluetooth connectivity, for example, for an electronic device with external power (e.g., credit card with a small battery and chip; Fitbit® or similar device; pendant or ring with internal power, etc.). These types of devices can be linked via NFC to a cell phone to provide authentication. For non-electrical device, there are a number of options to proceed. For example, a first method would be similar to card-keys used to open doors. For the present invention, the cardholder's cell phone may have a reader capable of reading or detecting an authorized embedded “key” in the non-electronic device. Alternatively, the non-electronic device may have a simple QR/Bar code that can be scanned or photo'd by the cardholder's cell phone to achieve a sense of proximity to the phone to demonstrate proximity of the authentication device 90 with the cashless transaction card or account number during the cashless transaction. Other methods are possible in accordance with embodiments of the present invention, and are contemplated by, and with the scope and spirit of the present invention.

In an alternative embodiment of the present invention, authentication can include a second authorization step that may require interaction between the server 20 and cardholder to further ensure use of the cashless transaction card is authorized. For example, security questions previously provided by the authorized cardholder during account set-up or during set-up of the present invention may be posed to the person attempting the transaction through a merchant point-of-sale terminal, on-line, over a network (e.g., a cell network), etc.

If the special purpose software 28 of the server 20 verifies that the authentication device 90 is in proximity with the cashless transaction card 60 at the time the cashless transaction is being undertaken, the transaction is authorized, provided that any other usage conditions are also satisfied. For example, if the cardholder entered a usage limit on the amount of a transaction that could be authorized for the cashless transaction card (e.g., at 252 of FIG. 6), the present invention also determines whether the total amount of the then-considered cashless transaction is with the usage conditions. If so, and if proximity of the electronic authentication device 90 is confirmed, then the present invention authorizes the cashless transaction, at 216 of FIG. 4.

Alternatively, authentication may be via non-electronic authentication device. For example, a cardholder may, during the process for linking a cashless transaction card with an authentication device depicted in FIG. 3, choose non-electronic authentication. For example, the cardholder may opt to use a word or phrase, or multiple words or phrases, as the means to authenticate use of his/her cashless transaction card. In this case, the entry in the enhanced security database 82 will contain the cardholder-provided word(s) and/or phrase(s) for the non-electronic authentication device 90. Thus, at 206 of FIG. 4, the special purpose software 28 of the server 20, having determined that the authentication device 90 is non-electronic, transmits, at 208, the non-electronic authentication to the merchant POS terminal 72, merchant website 74, cardholder smartphone 160, or other destination or device capable of receiving and transmitting data. Where the non-electronic authentication is word(s) or phrase(s), the transmission will query the cardholder to enter an answer or, alternatively, to select an answer from a plurality of answer choices. The cardholder enters his/her answer or selection, which is transmitted to the server 20 and compared, by the special purpose software 28 at 210, with the entry in the enhanced security database 82 for the cardholder's cashless transaction card. If the received answer or selection matches the entry in the enhanced security database 82, the transaction is authorized at 216, provided any cardholder-entered usage conditions are also satisfied. Otherwise, the transaction is denied at 214. For non-electronic authentication using a QR or Bar code, or other non-electronic device like a card key, authentication may be accomplished using a smart phone camera to read a QR or Bar code, or the smart phone may detect a proximity of the card key. In each case, the authentication stored in the enhanced security database 82 is compared with the authentication provided during the cashless transaction (whether from an electronic or n on-electronic device) to ensure they are the same or at least that the authentication device is authenticated.

Thus, the present invention provides a novel solution to the vexing problem of how to secure a cashless transaction card and card account from unauthorized use. By adding enhanced security to a cashless transaction card, the present invention significantly reduces, and may in fact eliminate, unauthorized use of a cashless transaction card and card account. In accordance with embodiments of the present invention, a cashless transaction card and card account are linked with an authentication device that must be in proximity with the cashless transaction card when that card is being used for a cashless transaction. In this way, the present invention makes unauthorized use of the card significantly less likely. The authentication device is chosen by the owner and linked thereby with the cashless transaction card and card account. Consequently, the owner (i.e., the cardholder) has control and most likely possession of the authentication device. Only when the authentication device is in proximity with the cashless transaction card will a cashless transaction be authorized. Thus, if a cashless transaction card is lost or stolen, or even if the cashless transaction card account number is stolen, neither can be used unless the authentication device is in proximity with the person attempting to complete a cashless transaction.

As will be appreciated by one skilled in the art, the present invention may be embodied as a system, method, or computer program product. Accordingly, the present invention may comprise computer hardware, software (including firmware, resident software, micro-code, etc.), or a combination of hardware and software. An aspect or aspects of the present invention may also take the form of a computer program product embodied in any tangible medium of expression having computer usable program code embodied in that medium.

Computer program code or applications for carrying out operations of the present invention may be written in any combination of one or more programming languages, including an object-oriented programming language such as Java, Smalltalk, C++, or the like and conventional procedural programming languages, such as Visual Basic, “C,” or similar programming languages. Other now known or hereafter developed programming languages may also be used for the present invention. The program code or application may execute partially or entirely on a single computing device, or partially or entirely on a plurality of computing devices.

The present invention is described below with reference to flowchart illustrations and/or block diagrams of methods, apparatuses (systems), and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks to carry out the present invention. These computer programmable instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provides processes for implementing the functions/acts specified in the flowchart and/or block diagram block or blocks.

Modifications to embodiments of the present invention are possible without departing from the scope of the invention as defined by the accompanying claims. Expressions such as “including,” “comprising,” “incorporating,” “consisting of,” “have,” “is,” used to describe and claim the present invention are intended to be construed in a non-exclusive manner, namely allowing for articles, components or elements not explicitly described herein also to be present. Reference to the singular is to be construed to relate to the plural, where applicable.

Although specific example embodiments have been described, it will be evident that various modifications and changes may be made to these embodiments without departing from the broader scope of the inventive subject matter described herein. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

What is claimed is:

1. A system to provide enhanced security against unauthorized use of a cashless transaction card, the system comprising:
an enhanced security database containing a plurality of database records, each for at least one cashless transaction card, each of the plurality of database records containing a primary authentication;
a server having a processor operable by a program of instructions stored in memory, the server being connectable to a network, the enhanced security database being accessible by the server; and
an authentication device having an authentication;
wherein, the program of instructions, when executed by the server processor, causes the server processor, during a cashless transaction, to:
receive an initiation of a cashless transaction, the initiation including an identifier of a cashless transaction card;
determine if the identifier of the cashless transaction card corresponds with one of the plurality of database records in the enhanced security database;
when the identifier of the cashless transaction card corresponds with one of the plurality of database records in the enhanced security database:
determine the authentication from the authentication device;
determine if the authentication from the authentication device is the same as the primary authentication in the one of the plurality of database records; and
authorize use of the cashless transaction card for the cashless transaction only when the authentication is the same as the primary authentication.

2. A system according to claim 1, wherein the authentication device is one of an electronic authentication device and a non-electronic authentication device.

3. A system according to claim 2, wherein the authentication device is a device that sends and receives information of any type over a network.

4. A system according to claim 3, wherein the authentication device is one of a smart phone, tablet, smart jewelry, and smart glasses.

5. A system according to claim 2, wherein the authentication device is an electronic authentication device and wherein the primary authentication comprises a unique identifier for the electronic authentication device.

6. A system according to claim 2, wherein the authentication device is a non-electronic authentication device and wherein the primary authentication comprises one of a QR code, a bar code, a word, a phrase and a card key.

7. A system according to claim 1, wherein at least one of the plurality of database records further contains a secondary authentication, and wherein, the program of instructions, when executed by the server processor, further causes the server processor, during a cashless transaction, to receive a second authentication and determine if the second authentication is the same as the secondary authentication.

8. A system to provide enhanced security against unauthorized use of a cashless transaction card, the system comprising:
an enhanced security database;
a server having a processor operable by a program of instructions stored in memory, the server being connectable to a network, the enhanced security database being accessible by the server; and
an authentication device having an authentication;
wherein, the program of instructions, when executed by the server processor, causes the server processor, prior to a cashless transaction, to:
create a database record containing a primary authentication in the enhanced security database for at least one cashless transaction card;
wherein, the program of instructions, when executed by the server processor, causes the server processor, during a cashless transaction, to:
receive an initiation of a cashless transaction, the initiation including an identifier of a cashless transaction card;
determine if the identifier of the cashless transaction card corresponds with at least the database record in the enhanced security database;
when the identifier of the cashless transaction card corresponds with at least the database record in the enhanced security database:
determine the authentication from the authentication device;
determine if the authentication from the authentication device is the same as the primary authentication in at least the database record; and
authorize use of the cashless transaction card for the cashless transaction only when the authentication is the same as the primary authentication.

9. A system according to claim 8, wherein the authentication device is one of an electronic authentication device and a non-electronic authentication device.

10. A system according to claim 9, wherein the authentication device is a device that sends and receives information of any type over a network.

11. A system according to claim 10, wherein the authentication device is one of a smart phone, tablet, smart jewelry, and smart glasses.

12. A system according to claim 9, wherein the authentication device is an electronic authentication device and wherein the primary authentication comprises a unique identifier for the electronic authentication device.

13. A system according to claim 9, wherein the authentication device is a non-electronic authentication device and wherein the primary authentication comprises one of a QR code, a bar code, a word, a phrase and a card key.

14. A system according to claim 8, wherein at least one of the plurality of database records further contains a secondary authentication, and wherein, the program of instructions, when executed by the server processor, further causes the server processor, during a cashless transaction, to receive a second authentication and determine if the second authentication is the same as the secondary authentication.

15. A system to provide enhanced security against unauthorized use of a cashless transaction card, the system comprising:
an enhanced security database containing a plurality of database records, each for at least one cashless transaction card, each of the plurality of database records containing a primary authentication;
a server having a processor operable by a program of instructions stored in memory, the server being connectable to a network, the enhanced security database being accessible by the server, the program of instructions, when executed by the server processor, causes the server processor, during a cashless transaction, to:
receive an initiation of a cashless transaction, the initiation including an identifier of a cashless transaction card;
determine if the identifier of the cashless transaction card corresponds with a database record in the enhanced security database;
when the identifier of the cashless transaction card corresponds with a database record in the enhanced security database:
verify the primary authentication; and
authorize use of the cashless transaction card for the cashless transaction only when the primary authentication is verified.
